(19) United States
(12) Patent Application Publication
(10) Pub. No.: US 2010/0305980 A1
(43) Pub. Date: Dec. 2, 2010

(54) Method Of Financing Minimally Capitalized Natural Resource Exploration Companies Through Risk Mitigation

(76) Inventor: Donald D. Sisk, New York, NY (US)

Correspondence Address: CROWELL & MORING LLP;INTELLECTUAL PROPERTY GROUP, P.O. BOX 14300, WASHINGTON, DC, 20044-4300, US

(21) Appl. No.: 12/474,945

(22) Filed: May 29, 2009

(51) Int. Cl. G06Q 40/00

(52) U.S. Cl. 705/4

(57) ABSTRACT

A junior exploration company must typically obtain financing for advanced stages of the natural resource recovery process, including the extraction stage. The method involves the procurement of errors and omissions insurance policy, that may name the investor as the beneficiary. If the amount of resources (e.g., minerals such as gold) discovered do not support the expected amount of return to the investor, the insurance company is expected to pay the claim to the intended beneficiary, namely the investor. If the amount of resources extracted are equal to or exceed the expected amount, then the insurance company does not pay on the policy, but the investor obtains the return on its investment based on the sale of the resources extracted. As a result, the risk to the investor is minimized and funding for the junior exploration company can be procured.

### FIELD OF THE INVENTION

The present invention pertains to procuring financing for natural resource recovery.

### BACKGROUND OF THE INVENTION

In the mining industry, a minimally capitalized company, which is a company with limited financial resources (a junior exploration company), typically may obtain an initial amount of funding from an investor that enables it to initiate its exploration activity. For exemplary purposes, that sum may be approximately equal to $500,000. With that initial funding, the company may commence several activities that will enable it to explore land, topography or oceanography, in an effort to locate and mine natural resources, including certain minerals, such as gold, iron, copper, bauxite, uranium, petroleum, diamonds or other precious metals, minerals and resources.

To initiate the recovery or extraction processes, a junior exploration company must first obtain rights to explore or use the land, topography or oceanography, for exploration or extraction purposes. These rights are generally known as concessions. Typically nation states, governmental actors or agencies hold those rights; however, a private party may instead own or control the rights. The government, or private party, essentially leases out these concessions for exploration or mining rights to the company. The government, or private party, leases this land, topography or oceanography to the junior exploration company, typically in exchange for the promise of a return or other remuneration based on a percentage of total output or revenue received (e.g., 15-20% of net profits).

Although the laws vary by geographic local where the extraction or recovery is to take place, the procurement of the mining concession typically must be accompanied, at least initially, by an exploration permit. That exploration permit may be included with the concession or the junior exploration company may need to procure it separately. That exploration permit allows the junior exploration company to perform a preliminary geochemical analysis, in which the junior exploration company tests the chemical makeup of small samples of the land, topography or oceanography, and then attempts to extrapolate that analysis to determine, or otherwise hypothesize, the amount of resources which may be present or recoverable on the area for which the concession has been obtained. The particular process involves exposing core samples of the land, topography or oceanography to chemical treatments that, based on the chemical or other reactions (or inaction), indicate what minerals, precious metals, commodities, or other resources, if any, are available. That analysis reveals to the geologist, in addition to the type of material, whether it is high grade, low grade, the purity, and what amount can be expected to be extracted or recovered. For exemplary purposes, the sum for the preliminary geochemical analysis and the exploration permit may be approximately $200,000-$300,000, or 40%-60% of the junior exploration company's initial capital.

If the results of that analysis are deemed to be satisfactory or otherwise make it an attractive opportunity, then the junior exploration company typically must obtain an extraction permit, which would allow it to initiate the actual extraction or recovery of resources from the land, topography or oceanography. The extraction process, however, is extremely costly, as it requires substantial labor and primarily front-loaded costs.

There are generally two main types of extraction that are typically employed by land based mining companies—alluvial extraction and deep mining.

Alluvial extraction, which is also known as strip mining depending on the resource being extracted, is used for certain commodities, such as coal or gold. In an alluvial mining operation, the top several meters of earth are stripped away, placed in a machine, sometimes called a washplant, that separates the surrounding substrate from the commodity. The mineral or other resource would then undergo further refinement processes to increase its purity and concomitantly, its value. For exemplary purposes, the upfront fee for the commencement of an alluvial mining operation may cost approximately $4 million.

With deep mining, also known as excavatory mining, the miners dig down much further into the earth. In the gold mining industry, for example, one would be digging for veins or lodes of gold, which are known as geological anomalies and which contain large, dense quantities of gold. Deep mining uses a type of sonogram or other electromagnetic analysis. It may require the shooting of electromagnetic waves from various vantage points over the ground to determine where veins or lodes may be located. Deep mining is a very expensive process compared to alluvial mining. For exemplary purposes, the upfront fee for deep mining may cost approximately $25 million depending on the size of the area to be excavated.

To perform such extraction, however, the junior exploration company typically must obtain further funding from investors. Most investors, however, would not invest in the company based only on the preliminary geochemical analysis that took place under the exploration permit process or other preliminary process. Rather, the investor may require a second large-scale geochemical analysis prior to providing funds to mitigate its risk pursuant to accepted risk mitigation practices. For exemplary purposes, the cost for that large-scale geochemical analysis may be equal to approximately $1,000,000-$1,500,000.

The preliminary geochemical analysis is often deemed too unreliable, and risky, for an investor to invest the significant capital that would be required for excavation to begin. If the junior exploration company is unable to obtain further funding, it would have to cease its mining activities. As a result, it would have spent all, or nearly all, of its initial capitalization without being able to actually extract or recover any resources which would allow it to receive a return on its initial investment. Furthermore, if that company is unable to proceed with mining, recovery or extraction on the property, it may be forced to relinquish its rights to the concession, which may create the opportunity for a competitor to extract resources on the concession.

Accordingly, there is a need in the industry for a method that allows a junior exploration company to obtain full funding for their resource excavation.

### SUMMARY OF THE INVENTION

The present invention enables junior exploration companies to obtain financing for advanced stages of the natural resource recovery process, including the extraction or recovery stage. The method involves the procurement of an errors and omissions insurance policy that may name the investor as the beneficiary. The insurance company may grant the policy based on the analysis performed in the preliminary geochemical audit. That policy offers protection to the investor, who would otherwise be unwilling to invest a large sum of money based on the uncertainty involved in resource exploration and/or extraction. If the amount of resources (e.g., minerals such as gold) discovered do not support the expected amount of return to the investor, the insurance company is expected to pay the claim to the intended beneficiary, namely the investor. If the amount of resources extracted are equal to or otherwise exceed the expected amount, then the insurance company does not pay on the policy, but the investor obtains the return on its investment based on the sale of the resources extracted. As a result, the risk to the investor is minimized or completely mitigated and funding for the junior exploration company can be procured.

### BRIEF DESCRIPTION OF THE DRAWINGS

FIG. 1A and FIG. 1B provide a flowchart showing an exemplary method for obtaining financing for mineral exploration.

FIG. 2 provides a chart showing asset allocation for the exemplary method for obtaining financing for mineral exploration.

### DETAILED DESCRIPTION OF THE INVENTION

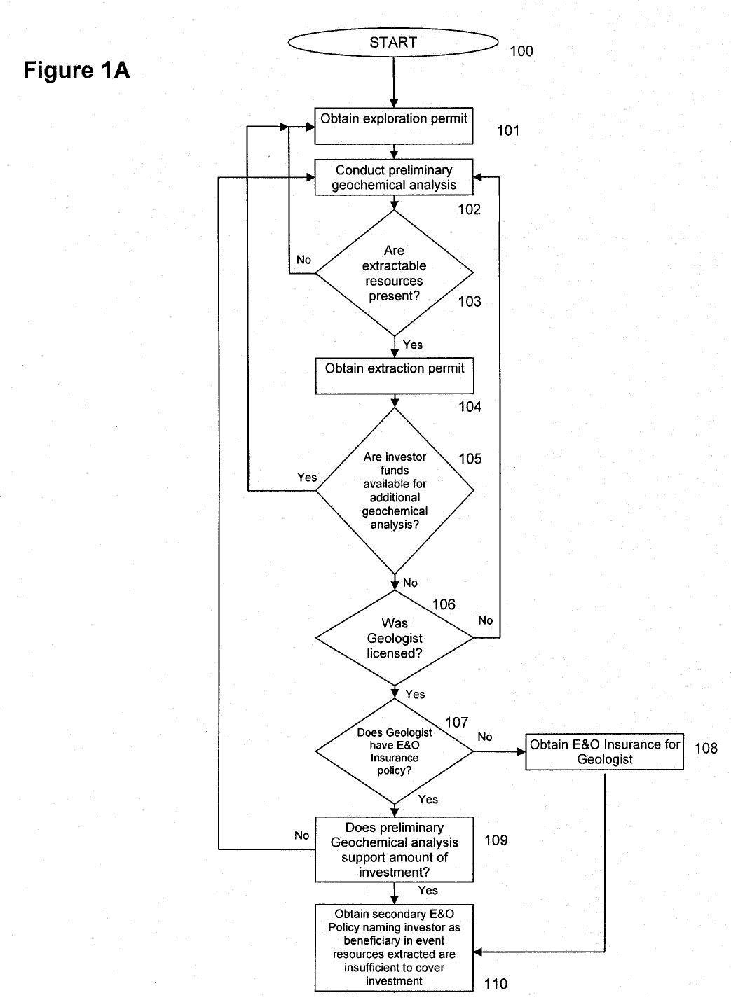

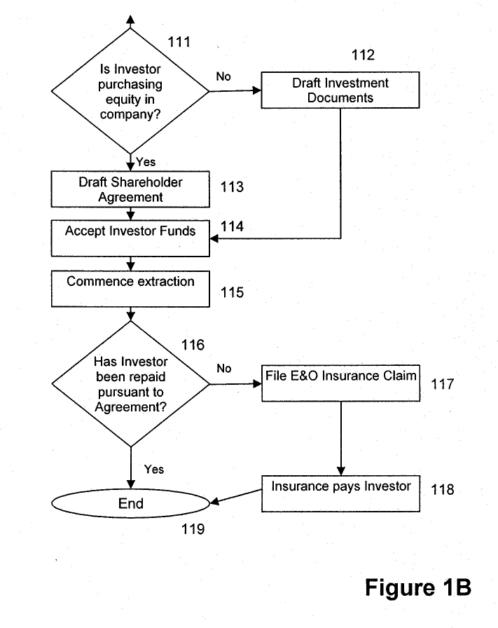

FIGS. 1A and 1B show an overview flowchart of an embodiment of the present invention that allows a minimally financed mineral exploration company to obtain further funding for natural resource (e.g., minerals such as gold, iron, copper, bauxite, uranium, coal, etc.) extraction.

The process starts at Step 100. At that stage, the junior exploration company has already received its initial funding and is ready to initiate the resource exploration process.

At Step 101, the junior exploration company obtains the necessary concession from the government, or other property owner, accompanied by an exploration permit that allows the company to analyze resource content in the land, topography or oceanography, and the potential amount available for recovery or extraction.

Next, at Step 102, the junior exploration company may employ, or otherwise contract with, a geologist who is preferably licensed, to conduct a preliminary geochemical analysis. Based on that analysis, the geologist provides projections as to the resources that may be present or otherwise extractable on the land, topography or oceanography. Such projections may include the type of material, quantity of the material, and quality of the material or resources to be recovered. The geologist may use any of a number of methods known by those skilled in the art to perform this analysis.

Following Step 102, at Step 103, the junior exploration company is able to make a preliminary determination, based upon the geologist's report, as to whether there are extractable resources (e.g., minerals such as gold) on the land, topography or oceanography. If there are no extractable resources, then the junior exploration company may return to Step 101 and obtain an exploration permit for another area of land, topography or oceanography. If it is preliminarily determined that the land, topography or oceanography may have sufficient extractable resources to support a sizeable investment, then the junior exploration company may (at Step 104) procure an extraction permit from the government, or other property owner, which would allow it to extract resources from the land, topography or oceanography. Of course, the specific jurisdiction may not require the procurement of an extraction permit, in which case this step can be omitted. Additionally, it is recognized that many jurisdictions may have other requirements that are not specifically referred to in the flowchart but are otherwise subsumed within the necessary activities contained within Step 101 and/or 104.

At Step 105, the junior exploration company may decide to perform an additional amount of preliminary geochemical analysis on an additional area land, topography or oceanography, if funds are still available.

Step 106 represents a double check on the geologist to make sure that he is licensed. If the geologist is not licensed, then the junior exploration company, proposed insurers and potential investors may have less faith in his report. If the geologist is licensed, then at Step 107, a junior exploration company may ensure that his report is covered by an errors and omission insurance policy. If the geologist is not covered, then an errors and omissions insurance policy may be procured on the geologist's behalf (Step 108). The geologist's errors and omissions insurance policy protects the geologist from liability in the event that he made an error or omission that causes harm to the claimant or beneficiary. The effect of procuring this errors and insurance policy may be to lower the cost of the errors and omissions policy described below in Step 110.

The investor, at Step 109, determines whether the preliminary geochemical analysis projects an amount of resources present on the land, topography or oceanography that would support a second round of investment that would warrant extraction by the junior exploration company. The type of extraction envisioned based on the preliminary geochemical analysis in a land based extraction would be alluvial, due to the lower cost involved and the ability to predict where best to commence deep mining operations in relation to the amount of resources alluvially extracted. This method, however, may be used with deep mining in the first instance as well.

If the resource projection from preliminary geochemical analysis is deemed satisfactory to the investor, then an errors and omissions insurance policy may be purchased that may name the investor as the beneficiary at Step 110. It may be appreciated that the cost of such insurance may be far less costly compared to the cost of extraction or further geochemical analysis. For exemplary purposes, the errors and omission insurance policy may cost $20,000 (or 4% of the junior exploration company's initial capital). The insurance company may grant the policy based on the analysis performed in the preliminary geochemical audit, after the insurance company conducts its own due diligence and risk mitigation analysis. That policy offers protection to the investor, who would otherwise be unwilling to invest the large sum of money based on the uncertainty involved in natural resource exploration and extraction.

If the amount of resources discovered is less than the expected amount, then the insurance company may pay the investor to cover its loss. If the amount of resources is equal to or exceeds the expected amount, then the insurance company does not pay on the policy, but the investor obtains a return on the investment based on the sale of the resources extracted. As a result, the risk to the investor is minimized and funding for the junior exploration company may be procured.

The errors and omissions insurance policy may be mandated or otherwise provided for in a written agreement, which may be in the form of an investment document (Step 112), or a shareholder agreement (113), depending on whether the investment arrangement is set up so that the investor receives equity in the company, or other form of return on the investment, in exchange for the investment capital.

Based on the errors and omissions insurance policy, together with the investment document or shareholder agreement, the investor may provide funds to the junior exploration company (Step 114) to begin extraction of the resources from the land, topography or oceanography (Step 115).

The success of the extraction will ensure whether the investor may be satisfactorily compensated per the investment document or shareholder agreement. If the extraction fails to yield results as projected, then the investor may file a claim under the errors and omissions insurance policy (Step 117) and thus may receive a return on the initial investment (Step 118). If the extraction does yield results as projected, then the investor may be compensated pursuant to the original agreements and not the errors and omissions insurance policy. After the full amount of the investment is covered, then the investor and junior exploration company should be profitable, and the errors and omissions policy may lapse or otherwise expire pursuant to its own terms (Step 119).

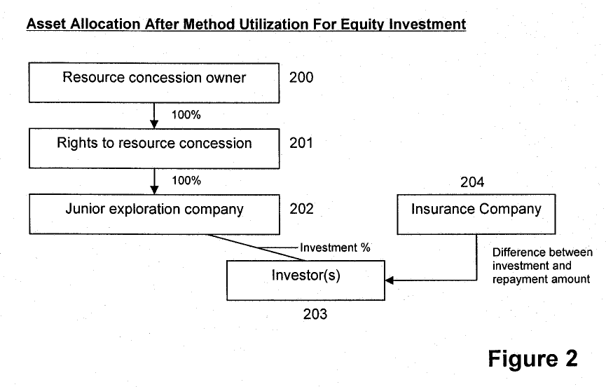

FIG. 2 provides an example of asset allocation in accordance with the present invention. Initially, as shown in Box 200, the resource concession owner, such as the government or property-owner, owns 100% of the assets to the land, topography or oceanography. The junior exploration company procures rights to the concession, including for example an exploration permit, which provides it with 100% of the rights to explore that land, as shown in Box 201. Then, as shown in Boxes 202, 203, and 204, when the junior exploration company seeks to procure the second stage of investment, an investor may take ownership in a percentage of the company, with an insurance company that provides an errors and omission insurance policy that may name the investor as the beneficiary potentially owing to the investor the difference between the investment and repayment amount if the amount of resources projected by the preliminary geochemical analysis is determined to be inaccurate during the excavation stage.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

The invention claimed is:

1. A method for financing natural resource recovery, comprising:
obtaining a preliminary geochemical analysis from a geologist projecting an amount of resources located in a predefined area;
establishing an agreement between an entity and an investor that specifies an amount of investor capital to be provided to the entity from the investor and a percentage of the entity to be owned by the investor;
obtaining an insurance policy that specifies payment is to be made to the investor of at least some of the amount of investor capital if the entity is unable to extract an amount of resources from the predefined area corresponding to the amount of resources projected by the preliminary geochemical analysis; and
receiving the amount of investor capital from the investor.

2. The method according to claim 1, wherein the investor is identified as the beneficiary of the insurance policy.

3. The method according to claim 1, wherein the resource is gold.

4. The method according to claim 1, wherein the entity is a junior exploration company.

5. The method according to claim 1, wherein the geologist is licensed by the government of the jurisdiction where the predefined area is located.

6. The method according to claim 1, wherein the amount of investor capital is sufficient to allow the entity to perform alluvial extraction.

7. The method according to claim 1, wherein the agreement is a shareholder agreement.

8. The method according to claim 1, wherein the predefined area is located outside of the United States.

9. The method according to claim 1, further comprising:
obtaining a second insurance policy on behalf of the geologist.

10. A method for financing natural resource recovery, comprising:
obtaining a preliminary geochemical analysis from a geologist projecting an amount of resources located in a predefined area;
establishing an agreement between an entity and an investor that specifies an amount of investor capital to be provided to the entity from the investor and a predetermined rate of return on a future disposition of resources to be provided to the investor from the entity;
obtaining an insurance policy that specifies payment is to be made to the investor of at least some of the amount of investor capital if the entity is unable to extract an amount of resources from the predefined area corresponding to the amount of resources projected by the preliminary geochemical analysis; and
receiving the amount of investor capital from the investor.

11. The method according to claim 10, wherein the investor is identified as the beneficiary of the insurance policy.

12. The method according to claim 11, wherein the resource is gold.

13. The method according to claim 12, wherein the entity is a junior exploration company.

14. The method according to claim 13, wherein the geologist is licensed by the government of the jurisdiction where the predefined area is located.

15. The method according to claim 14, wherein the investor capital is of an amount sufficient to allow the entity to perform alluvial extraction.

16. The method according to claim 14, wherein the amount of investor capital is sufficient to allow the entity to perform deep mining extraction.

17. The method according to claim 14, wherein the agreement is an investment document.

18. The method according to claim 17, wherein the predefined area is located outside of the United States.

19. The method according to claim 18, further comprising:
obtaining a second insurance policy on behalf of the geologist.
